(19) United States
(12) Patent Application Publication
(10) Pub. No.: US 2002/0038716 A1
(43) Pub. Date: Apr. 4, 2002

(54) Flat optical fiber bridging conduit with inertia damping

(76) Inventor: Ronald Anthony Pineda, Keller, TX (US)

Correspondence Address: RON PINEDA, 702 LAKEWAY DR., KELLER, TX, 76248, US

(21) Appl. No.: 09/682,710

(22) Filed: Oct. 9, 2001

(51) Int. Cl. H02G 3/04

(52) U.S. Cl. 174/68.3

(57) ABSTRACT

A cable bridging conduit for crush protection, impact inertia damping and waterproof routing of thin fiber optic cables directly on paved road surfaces. The conduit is optimally flat, flexible, plurally innerducted and spooled. The main body of the bridging conduit is made of solid synthetic hard rubber with a shallow topside surface trough for armor inserts and gentle topside edge tapering so as to provide maximum protection to thin fiber optic cables on paved roadsides and crossings while minimizing, absorbing and dissipating vehicular impact inertia. The bridging conduit is designed for permanent roadside surface mounting as a large scale suburban communication infrastructure component. Inertia damping technology is intrinsic in the design of the bridging conduit as a critical element of its durability and utility.

### BACKGROUND OF INVENTION

1. Field of the Invention

This invention relates to the protection and routing of commercially available fiber optic cables. The invention is specific to road surface mounting a continuous, thin, flat, hard rubber, plurally innerducted and armored cable bridging conduit along existing residential roadways and crossings where it is subject to heavy vehicular traffic and harsh environmental conditions.

Equal attention to protection of fiber optic cables and dissipating vehicular impact inertia is embodied in the design of the bridging conduit. Inertia damping technology is intrinsic in the design of the conduit as a critical feature of its durability and utility.

2. Discussion of the Prior Art

Permanent installation of fiber optic cable in an infrastructure context has to date been limited mainly to either subterranean burial in tubular conduit or aerial installation along utility poles. Both of these methods have found wide acceptance among communication providers for metropolitan point to point links and long distance communication carrier applications. Burial of fiber optic cable is the preferred method of installation for long distances for the extra protection and stable environmental conditions obtained in a subterranean environment.

The communication industry has long anticipated fiber optic cable as a total replacement for the copper cable currently used for residential communication infrastructure. Aside from serious cost constraints three physical limitations have impeded that goal. First, common fiber optic cable is sensitive to physical bending. Each fiber bend reduces the range of its optical signals. Metropolitan Fiber Ring technology now mixes scores of optical frequencies onto a single fiber which may then be serially routed through several metropolitan ring sites. Minimal loss of signal power due to fiber bending at each site can be tolerated as long as only a dozen or so metropolitan sites are involved.

The bending limitation becomes a serious contradiction to the geometry of closely spaced residential dwellings. Each shared fiber strand requires several bends at each residential property line and there are scores of residential properties within the normal range of an optical cable. Both aerial and buried fiber optic cable require at least two bends just to reach surface dwelling height where it can then be easily and safely spliced out to individual dwellings. Even those two bends, multiplied by the number of dwellings within the normal range of a straight line fiber cable, overwhelms the signal power and distance range of the fiber. Regenerating the signal numerous times is cost prohibitive and induces signal latency problems. Splicing individual residential connections inline with underground or aerial conduit is a tedious and expensive alternative as well.

Secondly, burial of fiber optic cable in urban or residential settings using tubular conduit is a costly and error prone process. Traditional trenching or horizontal drilling installation methods, in residential settings, are especially threatening to existing infrastructure, such as water lines, gas mains and buried cables. The cost of repairing collateral damage during installation only serves to increase the cost of initial installation and subsequent usage fees.

Thirdly, aerial installation of fiber optic cable has generally fallen from favor in the industry since it is subject to winter icing damage and municipal restrictions on utility pole placements.

If fiber optic cable is to fulfill a role in the residential communication infrastructure, a new method of installation is required. A method that reduces the number of bends required at each residential dwelling and reduces the installation cost of fiber optic cable will fill a vital need in the industry.

A flat surface mounted cable bridging conduit as detailed in the invention described here and cable bridges found in the prior art are now compared synonymously. Their application is identical in that they both prevent crushing of cables by moving vehicles. Hose and cable bridges are primarily intended to cross vehicular road paths while the flat cable bridging conduit of the current invention crosses vehicular road paths and parallels residential roadway side curbs as well. Many miles of the said conduit are used in practice compared to many feet of a cable bridge.

Hose and cable bridging protective devices do exist in the prior art. Of note is the fact that they promote modularity as a prime architectural goal. Both the fixed module lengths and modular features are in contrast to the continuous spool and unitary body of the invention described here. The prior art includes the following:

| Inventor | U.S. Pat. No. | Issue Date |
|---|---|---|
| Kostohris | 1,914,830 | June 20, 1933 |
| Jentzsch et al. | 3,965,967 | June 29, 1976 |
| Valeri | 4,067,258 | Jan. 10, 1978 |
| Smith et al. | 4,101,100 | July 18, 1978 |
| Zarembo | 4,677,799 | July 18, 1987 |
| Martin | 5,095,822 | Mar. 17, 1992 |
| Wegmann, Jr. | 5,267,367 | Dec. 7, 1993 |
| Ziaylek, Jr. et al. | 5,566,622 | Oct. 22, 1996 |
| Herman et al. | 5,777,266 | July 7, 1998 |
| Zienstra et al. | 6,067,681 | May 30, 2000 |
| Henry | 6,202,565 | Mar. 20, 2001 |

Kostohris discloses a modular flexible device that protects fire hoses by providing opposing ramps forming a passage over the hose. Kostohris shows that additional modular units may be placed end to end and secured together using loose fit dovetail lugs and recesses molded into the rubber of the device

Jentzsch et al. disclose a modular portable crossover for high tonnage earth moving vehicles having a U-shaped channel and a strip for covering the channel, and further includes a rigid plate or cable for connecting a tow vehicle to relocate the crossover.

Valeri discloses a modular crossover unit with a wedge-shaped rubber insert or plug that resists deflection and closes the hose receiving slot.

Smith et al. disclose an aircraft flight line servicing system whereby the distribution lines run under a modular multi-sectional unit of extruded aluminum sections that lock together.

Zarembo discloses a modular sectional raceway for use in combination with a pair of interconnected detection system panels. The sections are flexibly interconnected by pressure engaging members and at least one E-shaped girder structure underneath the entire width of the platform section providing at least one passageway for electrical wiring.

Martin discloses a modular cable crossover device for protecting electrical cables having a hinged lid secured by Velcro that covers the conduit and assumes part of the load. Modular sections can be coupled together by a strengthened interlocking system allowing for a variable length device.

Wegmann, Jr. discloses a modular interlocking, elongate ramp with a covered conduit channel. Adjacent ramp units are interlocked with members that project outwardly and upwardly from the end of each ramp unit to form a chain of ramp units.

Ziaylek, Jr. et al. disclose a modular collapsible hose bridge having a central support member that covers the hose, and two detachable ramps. Each ramp is attached by means of a curved lip that engages a curved slot running the length of the central support member. Ziaylek, Jr. et al., also show an alternative embodiment that permits several central support members to be connected side by side.

Herman et al. disclose a modular cable protection system that is expandable in both length and width using generic interlocking modules for the main conduit and generic interlocking ramp modules where edges do occur.

Zienstra et al. disclose a modular hose bridge that essentially clamps a hose into a modular clamping unit that is then attached onto modular ramp units.

Henry discloses a modular cable bridging device that is expandable both in length and width with a variety of central modular strips for various cable and hose sizes that dovetail together on their sides to form a wider central strip that is then dovetailed along each exterior side to a modular ramp unit.

3. Statement of the Problem

Protective cable bridges in the prior art are modular by design. Modularity is a benefit where the applied bridge length is confined to a given construction site or industrial area. In such cases modularity allows custom sizing of bridge lengths for various applications from a standard store of modular components. Custom applications ranging from tens to hundreds of feet are made practical through the modular architecture of the prior art.

Modularity is a disadvantage for large scale infrastructure applications. Where miles of surface cable protection are desired piecemeal construction from thousands of modular components becomes a labor intensive liability. In this situation a one piece continuous roll of cable protecting material is preferred. The profile height and overall width of such a protective cable bridge conduit should be as small as possible and sized specifically for the cable needed in the infrastructure application. An economy of scale can thus be realized.

None of the prior art provides for the large scale infrastructure needs outlined above. The fact that the prior art seeks to accommodate more than one size of cable or hose means that the bridges must be large enough to hold the largest cable or hose envisioned for use with the cable bridge. The prior art thus fails to accommodate a large scale infrastructure application where thin fiber optic cables need protection in a near equally thin continuous roll of protective cable bridging material.

Existing cable bridges in the prior art also fail to accommodate both of the related problems of minimizing vehicular rolling resistance and inertia damping from moving vehicles. The invention detailed here addresses both problems and further elevates the application of surface mount cable bridges to a permanent general communication infrastructure bridging conduit. Providing a means for vehicles to smoothly cross a surface cable bridging conduit at residential speed limits is critical in gaining wide acceptance for surface conduits as a general solution for affordable fiber optic cable infrastructure in residential areas.

Therefore, a road surface mounted, plurally innerducted, protective fiber optic cable bridging conduit for general permanent use on public roadbeds and crossings must be (1) optimally thin in profile height (2) have gently tapered, low angle, edges to minimize vehicular rolling resistance (3) be extremely durable, waterproof and (4) composed of a shock absorbent inertia damping material.

### SUMMARY OF INVENTION

Therefore, it is an object of this invention to provide a flat, edge tapered, fiber optic cable bridging conduit which enables quick, permanent installation of thin fiber optic cables using a flat, tapered, plurally innerducted conduit for mounting along public residential roadbeds and crossings at surface height as a means to reduce fiber bending, vehicular rolling resistance, impact inertia, installation and material costs substantially over the prior art.

It is another object of this invention to provide a fiber optic cable bridging conduit which is waterproof and highly resistant to chemicals and harsh environmental conditions.

It is another object of this invention to provide a fiber optic cable bridging conduit which is designed to receive segments of protective armor plating along its topside.

It is another object of this invention to provide a fiber optic cable bridging conduit which is flexible and may be extruded to arbitrary lengths for spooling.

It is another object of this invention to provide a means of reducing the number of bends required to splice a fiber optic cable at individual residential dwellings through the use of a surface mounted cable bridging conduit.

It is another object of this invention to provide a means to minimize, dampen and dissipate the impact inertia imparted from laterally moving rotating vehicle tires across the said conduit.

It is another object of this invention to provide a flat fiber optic cable bridging conduit suitable as a permanent and general residential infrastructure component along existing roadbeds and crossings.

Accordingly, a cable bridging conduit is provided that is thin, flat, flexible, armored, made of solid synthetic hard rubber, edge tapered and plurally innerducted. The conduit is specifically intended for permanent roadbed surface mounting along improved residential roadsides and crossings with shock absorbing inertia damping technology inherent in the materials and design thereof.

### BRIEF DESCRIPTION OF DRAWINGS

Reference may now be made to the following detailed description of preferred embodiments of the invention using the attached and numbered drawings in which:

FIG. 1 illustrates a perspective view of the surface mount fiber optic cable bridging conduit with armor plating inserted in its topside external receptacle trough.

FIG. 2 illustrates an exploded perspective view of the said bridging conduit of FIG. 1 with its armor plating raised above its external receptacle trough to show the external trough and a dashed line depiction of a geometrically tuned innerduct traversing the said conduit just below the external receptacle trough.

FIG. 3 illustrates one embodiment of a cross sectional view of the said conduit with armor plating removed to clearly show a shallow external trough and a plurality of innerduct openings showing on its face.

### DETAILED DESCRIPTION

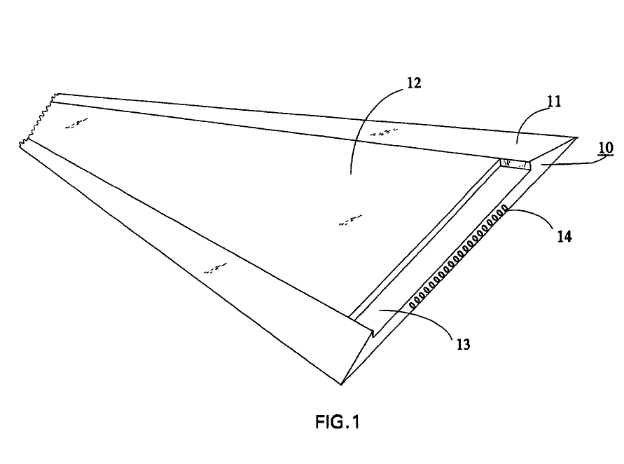

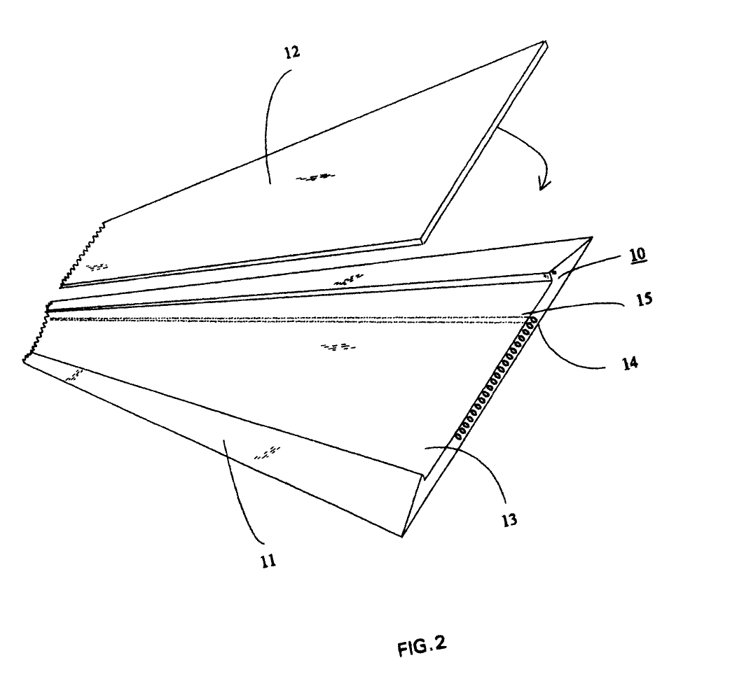

Referring specifically to the drawings labeled FIG. 1 and FIG. 2 there is illustrated a flat fiber optic cable bridging conduit 10 which essentially comprises a flat flexible hard rubber strip of arbitrary length with a shorter segment of steel plate 72 inserted into an external receiving trough 73, in FIG. 1, and floating above the external trough 73 in FIG. 2.

A plurality of fiber optic cable innerducts 14 are shown to internally traverse the said conduit 10. FIG. 2 shows one of the innerducts 15 as seen through dashed lines below the external trough 13.

Innerducts 14 are geometrically tuned to a dissonant vibration mode of the inertia impact induced by a typical tire tread impacting at residential road speeds by being both physically smaller than a typical tire tread and the typical space between the treads as a first of five means to dampen a resonant acoustic shock reflection imparted from the impact inertia of a laterally moving and rotating tire tread.

Thus an impact induced acoustic shock wave that is reliably dissonant to a primary impact shock wave is allowed to propagate through innerducts 14 which also serve as passive baffles and a second of five means to dissipate tire impact inertia through aeroelastic damping in the airspace of the innerducts 14.

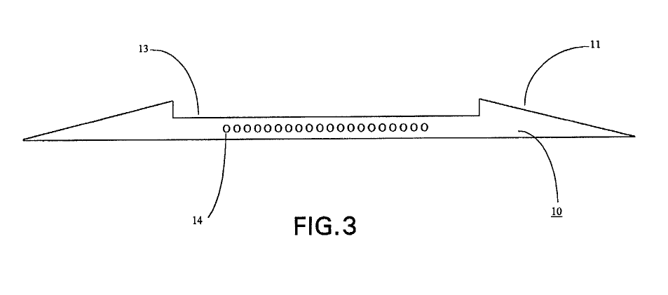

The drawing labeled FIG. 3 illustrates a cross sectional view of the said bridging conduit 10 with exterior trough 13 clearly delineated and with a plurality of innerduct openings 14 shown. The cross sectional view of the bridging conduit 10 depicts a peak profile height that is geometrically tuned to a dissonant vibration mode by being less than a typical tire tread height as a third of five means to reliably dampen the fundamental vibration mode that would normally resonate with the impact inertia emanating from a laterally moving and rotating tire tread across any single point on the bridging conduit 10 if the profile height equaled or exceeded tread height.

Both edges of the bridging conduit 10 are gently edge tapered 11 as a forth of five means to dampen vehicular impact inertia and minimize rolling resistance through deflection.

Solid synthetic hard rubber is a preferred construction material for the bridging conduit 10 for its material likeness to a typical vehicular tire tread for which it is designed to withstand and react to. Optimal impact inertia transfer absorption from a laterally moving and rotating tire is thus gained by approximately matching the synthetic hard rubber materials used in a typical vehicular tire tread with the material used in the bridging conduit 10. Transfer absorption and viscous damping is thus optimized as a fifth of five means of impact inertia damping.

While there has been shown and described what are considered to be preferred embodiments of the invention it will of course be understood that various modifications and changes in form or detail could readily be made without departing from the sprit of the invention. It is therefore intended that the invention not be limited to the exact form and detail herein shown and described nor to anything less than the whole of the invention herein disclosed as hereafter claimed.

What is claimed is:

1. A flat flexible cable bridging conduit that is plurally innerducted with tapered topside edges and a narrower topside exterior shallow central trough to receive armor plating as a means to permanently mount fiber optic cables directly on improved roadbeds comprising:
(a) said bridging conduit constructed from an extruded synthetic hard rubber strip that is spooled to arbitrary lengths.
(b) a flat bottom side suitable for adhesion to roadbeds.
(c) said bridging conduit is gently edge tapered along each topside edge to minimize vehicular rolling resistance.
(d) said topside exterior shallow central trough along the entire length of the said bridging conduit for insertion of said armor plate segments along the length of the said bridging conduit.
(e) said armor plating inserted into said shallow trough as segments of steel strips.
(f) said innerduct channels for passage and containment of said fiber optic cables.

2. A bridging conduit as claimed in claim 1 that embeds five instances of inertia damping as a product of its materials and physical design as a means to minimize, absorb and dissipate vehicular impact inertia through the said bridging conduit.
(a) Said innerducts are geometrically tuned for dissonant modes of absorption as a first means of said inertia damping.
(b) Said innerducts employed as passive baffles as a second means of said inertia damping.
(c) Said bridging conduit profile height geometrically tuned below typical tire tread height to retard induced resonance as a third means of said inertia damping.
(d) Said gentle topside edge tapering is employed as a forth means of said inertia damping through deflection.
(e) Construction material is matched to typical vehicular tire material as a fifth means to maximize said inertia damping through optimal transfer absorption.
